(19) United States
(12) Patent Application Publication
(10) Pub. No.: US 2006/0266191 A1
(43) Pub. Date: Nov. 30, 2006

(54) Dual function apparatus for cutting and punching

(75) Inventor: Chao-Tung Shih, Jhonghe City (TW)

Correspondence Address: HDSL, 4331 STEVENS BATTLE LANE, FAIRFAX, VA, 22033, US

(73) Assignee: Cheng Tien Int'l Corp.

(21) Appl. No.: 11/138,493

(22) Filed: May 27, 2005

(51) Int. Cl. B26D 5/08; B26D 1/12

(52) U.S. Cl. 83/614; 83/667

(57) ABSTRACT

A dual function apparatus for cutting and punching includes a main body, a knife switch and at least one punching unit. The main body includes a frame and a connector arranged on the frame. The knife switch is arranged on the frame and includes a switching member for changing a processing position and a knife member arranged corresponding to the switching member. The punching unit is arranged on the frame and corresponding to the switching member. The knife switch is moved for changing the processing position and providing dual function of cutting and punching.

### BACKGROUND OF THE INVENTION

1. Field of the Invention

The present invention relates to a dual function apparatus for cutting and punching, especially to a stationary for cutting and punching paper and changing position by moving a switching member, thus providing dual function apparatus for cutting and punching paper.

2. Description of Related Art

For city people, especially for workers in office, they often need lots of stationeries to facility daily work. More particularly, the puncher and cutter generally occupy considerable space. Therefore, the tidy arrangement and placement thereof will be great help to efficient work and the puncher and cutter deserve considerable research.

The conventional way for hole-punching a paper is to use a puncher with different sizes. For example, the file clips with two holes, three holes and fourth holes format are available and the punchers should have associated holes and punching pitch to match with those file clips. The punchers generally have bulky sizes and are not convenient for user. Moreover, the conventional paper cutting work relies on scissors and cutting knife, which cannot achieve straight cutting edge conveniently. The cutter can provide straight cutting edge and fast cutting speed. However, the size of the cutter is also bulky.

Therefore, it is desirable to combine the function of puncher and cutter to one composite unit. The composite unit has dual function and is compact for placement and storage.

### SUMMARY OF THE INVENTION

The present invention provides a stationary for cutting and punching paper and changing position by moving a switching member, thus providing dual function apparatus for cutting and punching paper.

Accordingly, the present invention provides a dual function apparatus for cutting and punching, which includes a main body, a knife switch and at least one punching unit. The main body includes a frame and a connector arranged on the frame. The knife switch is arranged on the frame and includes a switching member for changing a processing position and a knife member arranged corresponding to the switching member. The punching unit is arranged on the frame and corresponding to the switching member. The knife switch is moved for changing the processing position and providing dual function of cutting and punching.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows the exploded view of the present invention.

FIG. 2 shows the exploded view of the retainer of present invention.

FIG. 3 shows the exploded view of the locker of present invention.

FIG. 4 shows the exploded view of the knife switch of present invention.

FIG. 5 shows the exploded view of the punching unit of present invention.

FIG. 6 shows the exploded view of the base of present invention.

FIG. 7 shows the perspective view of the present invention assembled with base.

FIG. 8 shows the present invention used in punching application.

FIG. 9 shows the present invention used in cutting thin paper application.

FIG. 10 is a sectional shows the present invention used in cutting thick paper application.

FIG. 11 is another sectional shows the present invention used in cutting thick paper application.

### DETAILED DESCRIPTION OF THE INVENTION

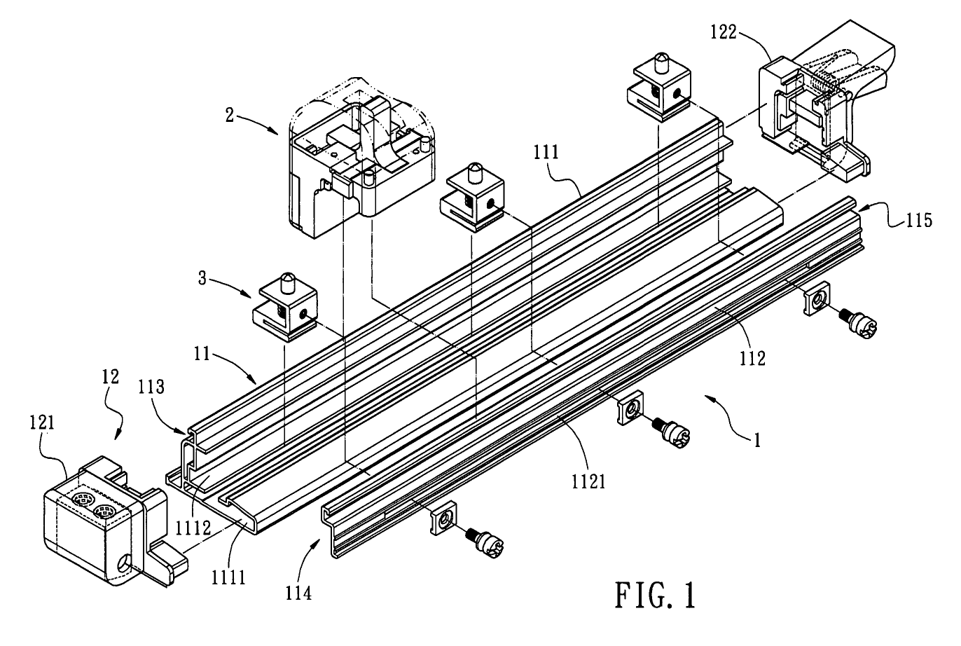

FIG. 1 shows the dual function apparatus for cutting and punching according to the preset invention. The dual function apparatus for cutting and punching comprises a main body 1, a knife switch 2 and at least one punching unit 3.

The main body 1 comprises a frame 11 and a connector 12 connected to the frame 11. The frame 11 comprises a first rack 111 and a second rack 112, both of which are elongated strip made of aluminum alloy. The first rack 111 and a second rack 112 further comprise a sliding rail 113 atop thereof and a left coupling section 114 and a right coupling section 115 on both ends thereof. The first rack 111 comprises a dust retainer 1111 and a supporter 1112 atop the dust retainer 1111. The second rack 112 comprises an elongated slot 1121 on lateral side thereof.

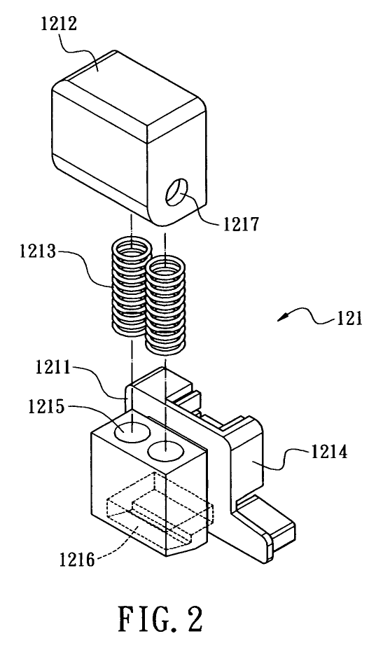

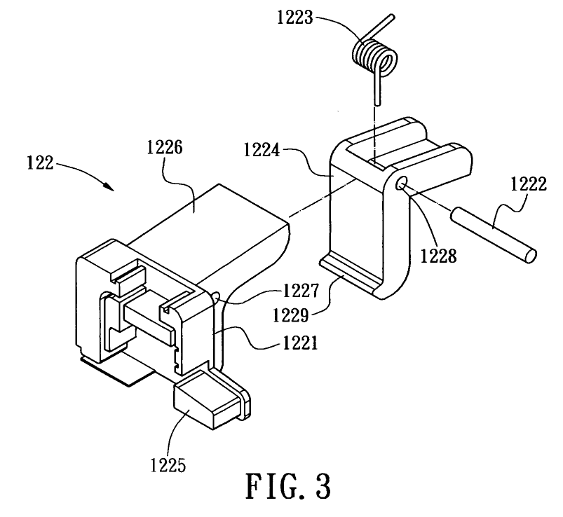

With reference now to FIGS. 2 and 3, the connector 12 comprises a retainer 121 and a locker 122. The retainer 121 comprises a movable block 1211, a fixed block 1212 and a plurality of compressed springs 1213. The movable block 1211 comprises an insertion section 1214 at rear side thereof and two longitudinal holes 1215 at front side thereof. The movable block 1211 further comprises an L-shaped dust entry groove 1216 there below. The insertion section 1214 is engaged with the left coupling section 114 of the frame 11. The longitudinal holes 1215 are used for contain the compressed springs 1213 and are pressed by embedding the fixed block 1212. The fixed block 1212 comprises a through hole 1217. The locker 122 comprises a fixing stage 1221, a shaft 1222, a torque spring 1223 and a handle 1224. The fixing stage 1221 also comprises an insertion section 1225 for engaging with the right coupling section 115 of the frame 11. The fixing stage 1221 also comprises a supporting tab 1226, axial holes 1227 and 1228 defined on the supporting tab 1226 and the handle 1224. The shaft 1222 passes the axial holes 1227 and 1228 and the torque spring 1223 to form the locker 122 by the elastic force of the torque spring 1223.

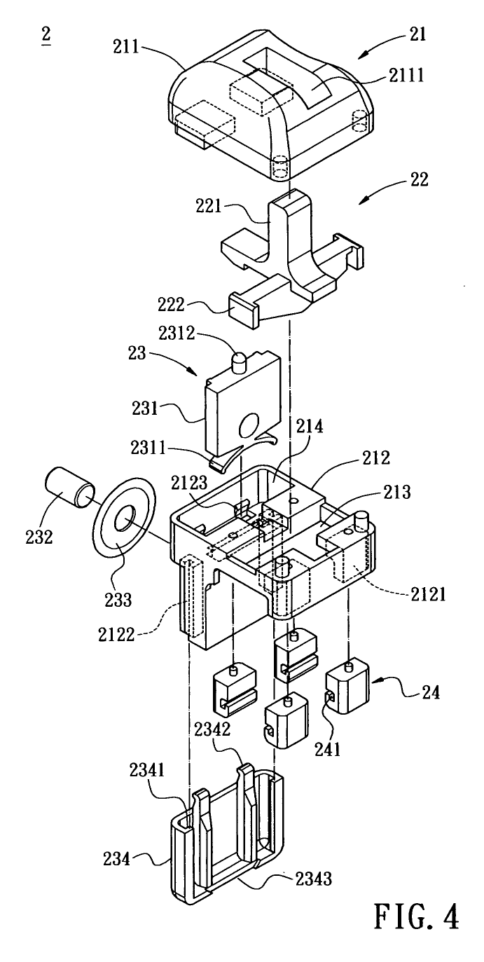

FIG. 4 shows a perspective view of the knife switch 2 according to the preset invention. The knife switch 2 comprises a cover member 21, a switching member 22, a knife member 23 and a plurality of connection blocks 24. The cover member 21 comprises an upper cover 211 and a lower cover 212 connected below the upper cover 211. A first receiving section 213 and a second receiving section 214 are defined in the upper cover 211 and the lower cover 212. The upper cover 211 comprises a through groove 2111 at center thereof. The lower cover 212 is inverted L shape and comprises dents 2121 at four corners of the first receiving section 213 and below a lateral plate thereof. The lower cover 212 further comprises longitudinal grooves 2122 on two sides of the longitudinal plate thereof. Two locking grooves 2123 are defined on the second receiving section 214. The switching member 22 is placed between the upper cover 211 and the lower cover 212 and comprises a push rod 221 and a lower pressing section 222 below the push rod 221. The push rod 221 is of inverted T shape and comprises a longitudinal section exposed out of the through groove 2111, whereby the push rod 221 can be moved forward and backward on the upper cover 211.

The lower pressing section 222 is an inverted isosceles triangle and placed in the first receiving section 213 and the bottom thereof is exposed out of the lateral plate of the lower cover 212. The knife member 23 is connected to the longitudinal plate of the lower cover 212 and comprises a knife rack 231, a knife shaft 232, a cutting knife 233 and a protective cover 234. The knife rack 231 is placed in the second receiving section 214 and comprises a semi-annulus tongue 2311 on bottom thereof and a cylinder 2312 projecting from top center thereof. The knife shaft 232 passes the cutting knife 233 and then is fixed to one side of the knife rack 231. The protective cover 234 comprises a guiding rail 2341 and a hook 2342. The guiding rail 2341 is corresponding to the longitudinal grooves 2122 and the hook 2342 is locked to the locking grooves 2123 of the lower cover 212. The protective cover 234 comprises a cutout 2343 on bottom edge thereof and the cutout 2343 is function for the movement of the cutting knife 233. The connection block 24 comprises embedding groove 241 on inner side thereof and corresponding to the sliding rail 113 and fit to the dents 2121.

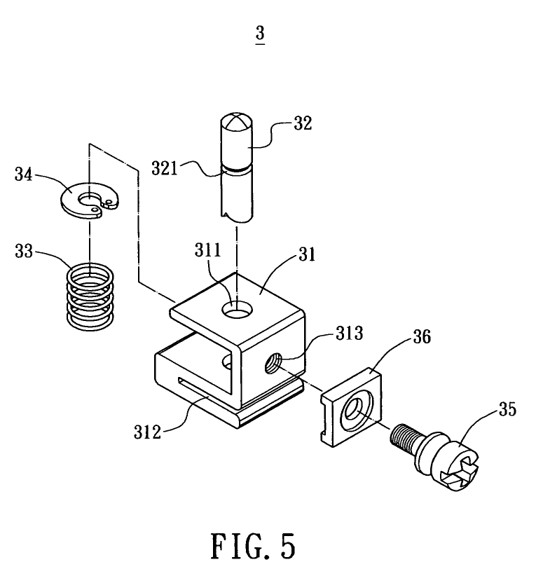

FIG. 5 shows the exploded view of the punching unit 3, which can be arranged with one or more set to fit user need. The punching unit 3 comprises a puncher rack 31, a punching knife 32, an elastic body 33, a fastener 34, a damper 35 and a tab 36. The puncher rack 31 is a main body with integrally formed U shape and comprises through hole 311 on upper plate and lower plate thereof. A landscape paper tank 312 is defined at center of the lower plate and thread hole 313 is defined at center of lateral plate thereof. The thread hole 313 facilitates the damper 35 for passing the tab 36 and the elongated slot 1121 for fixing. The punching knife 32 comprises an annulus dent 321, which is passes the through hole 311 and the elastic body 33. Afterward, the fastener 34 is engaged into the annulus dent 321; and the elastic body 33 and the fastener 34 are clamped between the upper plate and lower plate of the puncher rack 31.

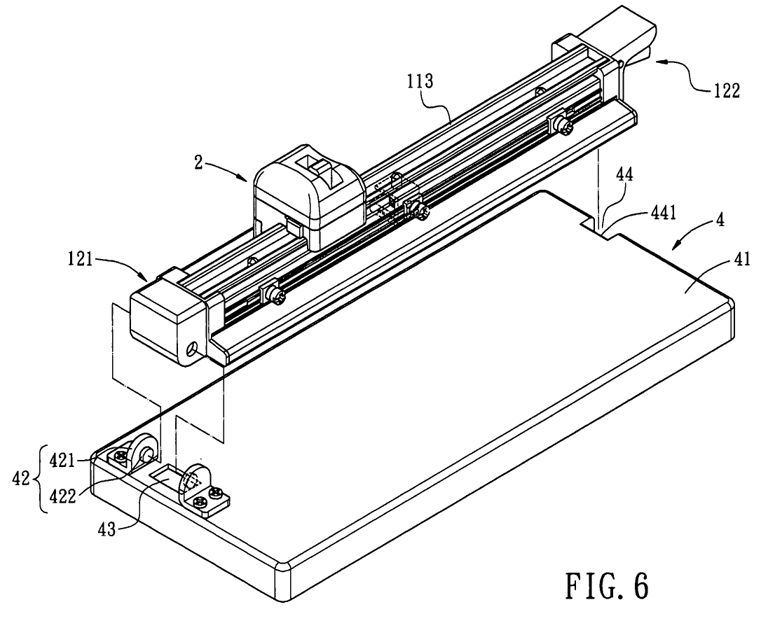

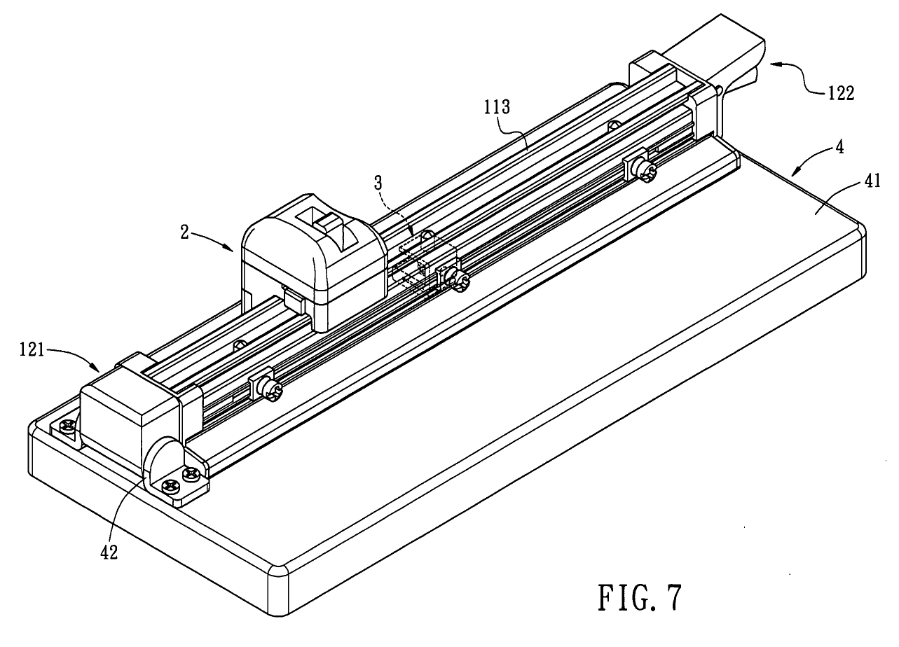

With reference to FIGS. 6 and 7, the dual function apparatus for cutting and punching according to the preset invention further comprises a base 4 being an elongated hollow body. The base 4 comprises a top plate 41 with a pivot 42 at left side thereof. The pivot 42 comprises two L shaped racks 421 and pivotal shaft 422 extended outward from the L shaped racks 421. A dust opening 43 is defined on the top plate 41 of the base 4 such that the paper dust in the dust retainer 1111 can be sent to the hollow body of the base 4 when the body 10 is lifted with the retainer 121 as a rotation center Moreover, an opening 44 is defined at right side of the base 4 and corresponding to the pivot 42 and a locking section 441 is formed at inner side of the opening 44. The opening 44 has width corresponding to the handle 1224 of the locker 122 as shown in FIG. 3. The locking section 411 is locked with the hook 1229 of the locker 122 as shown in FIG. 3.

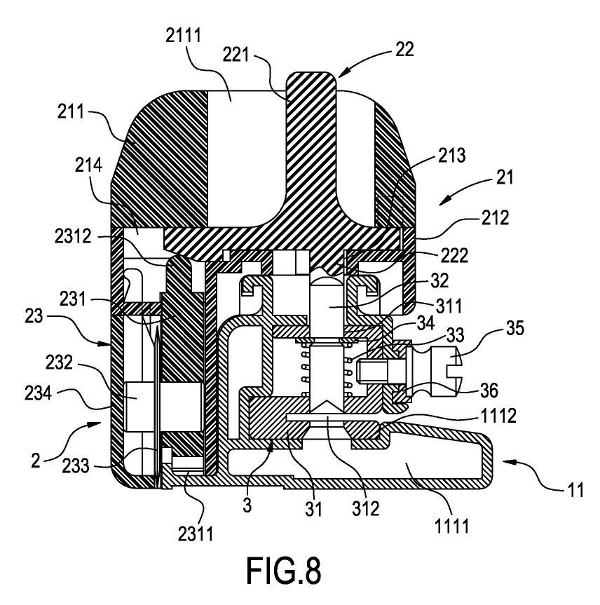

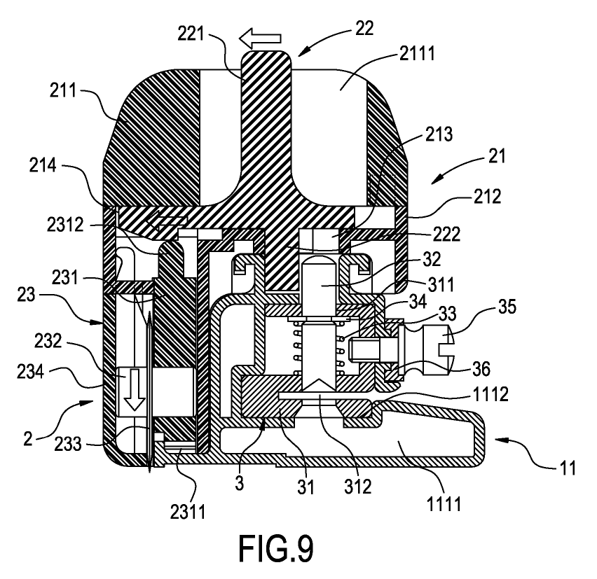

With reference to FIGS. 8 and 9, the punching knife 32 is selected for the paper to be punched. The punching knife 32 is then placed into the supporter 1112 of the first rack 111 and the damper 35 passes into the elongated slot 1121 to screwing with the thread hole 313. The lower pressing section 222 is placed atop the punching knife 32 and the knife switch 2 is moved along the rail 113 such that the lower pressing section 222 pushes downward the punching knife 32. The knife 233 exposes out of the bottom of the first rack 111 through the cutout 2343 and the knife switch 2 is moved along the rail 113 to cut the paper with the knife 233.

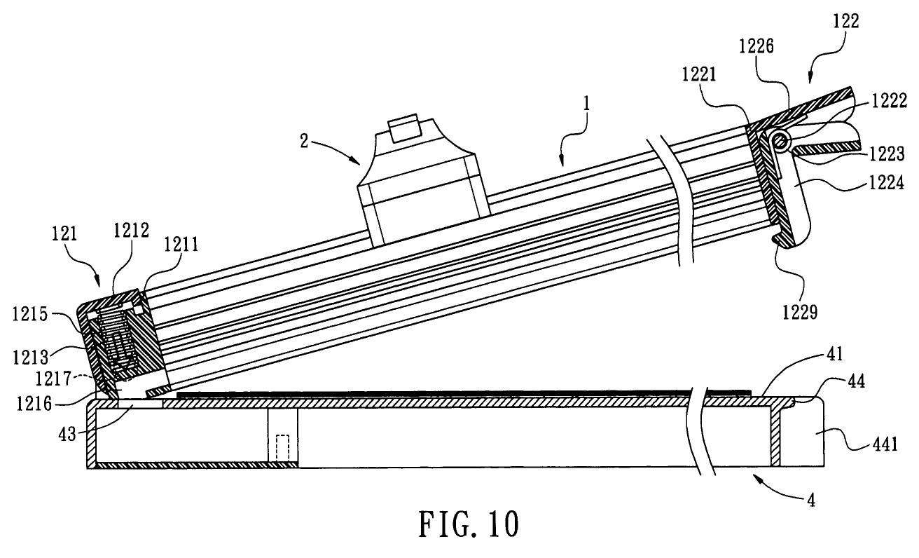

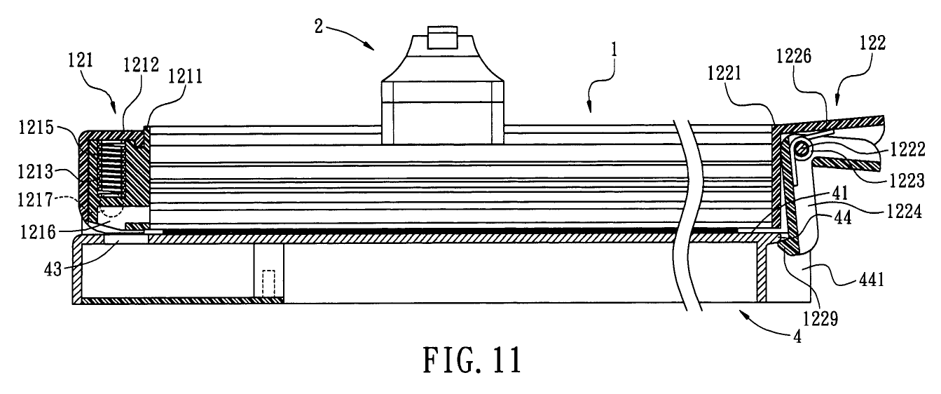

With reference to FIGS. 10 and 11, the papers are stacked and placed atop the top plate 41 when lots of papers are to be cut. The locker 122 is pressed downward with the through hole 1218 as a rotation center. The handle 1224 is pressed with the shaft 1222 as center to expand the hook 1229 for locking to the locking section 441. The movable block 1211 and the compressed spring 1213 will lift the body 1 to horizontal state to facilitate the cutting of thick and massive papers.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

1. A dual function apparatus for cutting and punching, comprising:
a main body comprising a frame and a connector arranged on the frame;
a knife switch arranged on the frame and comprising a switching member for changing a processing position and a knife member arranged corresponding to the switching member; and
at least one punching unit arranged on the frame and corresponding to the switching member; whereby the knife switch is moved for changing the processing position and providing dual function of cutting and punching
wherein the frame comprises a first rack and a second rack both of which comprise a sliding rail atop and a left coupling and a right coupling section on both ends thereof,
wherein the connector comprises a retainer and a locker which comprises an insertion section corresponding to the left coupling and the right coupling section, and
wherein the retainer comprises a movable block a fixed block and a plurality of compressed springs, the movable block comprises a hole or receiving the compressed springs and for the embedding of the fixed block.

2. (canceled)

3. The dual function apparatus for cutting and punching as in claim 1, wherein the first rack comprises a dust container on bottom thereof and a supporter atop the dust container for connecting to the punching unit.

4. (canceled)

5. (canceled)

6. The dual function apparatus for cutting and punching as in claim 1, further comprising a dust entry groove below the movable block.

7. The dual function apparatus for cutting and punching as in claim 1, wherein the locker comprises a fixing stage, a shaft, a torque spring and a handle, the fixing stage comprising a supporting tab, axial holes defined on the supporting tab and the handle, the shaft passing the axial holes and the torque spring.

8. The dual function apparatus for cutting and punching as in claim 1, wherein the knife switch comprises a cover member and a plurality of connection blocks, the cover member receives the switching member, the switching member comprises a push rod projected out of the cover member and a lower pressing section connected to the push rod and projected out of the cover member.

9. The dual function apparatus for cutting and punching as in claim 8, wherein the lower pressing section is an inverted isosceles triangle.

10. The dual function apparatus for cutting and punching as in claim 8, wherein the cover member comprises a first receiving section and a second receiving section, the first receiving section comprises dents defined on edges thereof and the dents used for receiving the connection block and the second receiving section used for receiving the knife member.

11. (canceled)

12. The dual function apparatus for cutting and punching as in claim 8, wherein the cover member comprises longitudinal grooves and locking grooves, and the knife member comprises a protective cover with a guiding rail and a hook corresponding to the longitudinal grooves and the locking grooves.

13. The dual function apparatus for cutting and punching as in claim 12, wherein the protective cover comprises a cutout on bottom thereof and through the cutout the knife can be moved in and out.

14. The dual function apparatus for cutting and punching as in claim 11, wherein the knife rack comprises a semi-annulus tongue on the bottom thereof.

15. The dual function apparatus for cutting and punching as in claim 1, further comprising a base with a pivot on one side thereof and connected to one end of the connector.

16. The dual function apparatus for cutting and punching as in claim 15, wherein the base comprises an opening connected to another end of the connector.

17. A dual function apparatus for cutting and punching, comprising:
a main body comprising a frame and a connector arranged on the frame;
a knife switch arranged on the frame and comprising a switching member for changing a processing position and a knife member arranged corresponding to the switching member; and
at least one punching unit arranged on the frame and corresponding to the switching member; whereby the knife switch is moved for changing the processing position and providing dual function of cutting and punching
wherein the frame comprises a first rack and a second rack, both of which comprises a sliding rail atop and a left coupling and a right coupling section on both ends thereof,
wherein the connector comprises a retainer and a locker, which comprises an insertion section corresponding to the left coupling and the right coupling section, and
wherein the locker comprises a fixing stage, a shaft, a torque spring and a handle, the fixing stage comprising a supporting tab, axial holes defined on the supporting tab and the handle, the shaft passing the axial holes and the torque spring.

18. The dual function apparatus for cutting and punching as in claim 17, wherein the retainer comprises a movable block, a fixed block and a plurality of compressed springs, the movable block comprises a hole or receiving the compressed springs and for the embedding of the fixed block.
